(19) United States
(12) Patent Application Publication
(10) Pub. No.: US 2026/0089641 A1
(43) Pub. Date: Mar. 26, 2026

(54) METHOD AND APPARATUS FOR MEASURING CELL, METHOD AND APPARATUS FOR CONFIGURATION, TERMINAL, AND NETWORK SIDE DEVICE

(71) Applicant: VIVO MOBILE COMMUNICATION CO., LTD., Dongguan (CN)

(72) Inventor: Yangyang WANG, Dongguan (CN)

(21) Appl. No.: 19/408,414

(22) Filed: Dec. 4, 2025

Related U.S. Application Data
(63) Continuation of application No. PCT/CN2024/098312, filed on Jun. 11, 2024.

(30) Foreign Application Priority Data
Jun. 16, 2023 (CN) 202310722815.X

(51) Int. Cl. H04W 52/02; H04W 36/00

(52) U.S. Cl. CPC H04W 52/0235; H04W 36/0085

(57) ABSTRACT

The present disclosure discloses a method and apparatus for measuring a cell, a method and apparatus for configuration, a terminal, and a network side device, and belongs to the technical field of communication. The method for measuring a cell according to embodiments of the present disclosure includes: measuring, by the terminal, a neighboring cell by using a low power wake up radio (LP-WUR).

### CROSS-REFERENCE TO RELATED APPLICATIONS

The present disclosure is a continuation of International Patent Application No. PCT/CN2024/098312, filed on Jun. 11, 2024, which claims the priority to Chinese Patent Application No. 202310722815.X filed in China on Jun. 16, 2023, both of which is incorporated herein in their entirety by reference.

### TECHNICAL FIELD

The present disclosure belongs to the technical field of communication, and particularly relates to a method and apparatus for measuring a cell, a method and apparatus for configuration, a terminal, and a network side device.

### BACKGROUND

In order to conserve energy, a low power wake up radio (Low Power Wake Up Radio, LP-WUR) is introduced into the related art. When the LP-WUR of a terminal includes a main communication module and a low-power reception module, one work mode is that the main communication module is configured to send and receive mobile communication data, and the low-power reception module is configured to receive a wake-up signal. In an energy-conserving state, the terminal activates the low-power reception module to monitor the wake-up signal and deactivates all or most functions of the main communication module. When downlink data arrive, the network will send the wake-up signal to the terminal. After the terminal monitors the wake-up signal through the low-power reception module, the terminal will trigger the main communication module to enter a work state from a deactivated state or a near-deactivated state, and the low-power reception module will enter a deactivated state from a work state. At present, the terminal usually uses a master radio for neighboring cell measurement.

### SUMMARY

Embodiments of the present disclosure provide a method and apparatus for measuring a cell, a method and apparatus for configuration, a terminal, and a network side device.

In a first aspect, a method for measuring a cell is provided. The method is performed by a terminal and includes:
measuring, by a terminal, a neighboring cell by using a low power wake up radio (LP-WUR).

In a second aspect, a method for configuration is provided. The method is performed by a network side device and the method includes:
sending, by the network side device, a first information or a second information to a terminal, where the first information is used for measuring a neighboring cell by using an LP-WUR, the second information is used for measuring the neighboring cell by using the LP-WUR, that is, the first information or the second information is used for configuring how to measure the neighboring cell by using the LP-WUR for the terminal;
where, the first information includes at least one of the following:
a first indication information corresponding to a first frequency point, where the first indication information is used for indicating whether to measure the first frequency point when the terminal measures the neighboring cell by using the LP-WUR;
a second indication information corresponding to a first cell, where the second indication information is used for indicating whether to measure the first cell when the terminal measures the neighboring cell by using the LP-WUR;
a third indication information corresponding to a second frequency point and a second cell, where the third indication information is used for indicating whether to measure the second frequency point and the second cell when the terminal measures the neighboring cell by using the LP-WUR;
a frequency point information or a cell information, where the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and
a SMTC information; and
the second information includes at least one of the following:
a fourth indication information, where the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point, where the third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point;
an information of a fourth cell associated with a third cell, where the information of the fourth cell is used for indicating that the third cell is synchronized with the fourth cell;
a configuration information of an LP-SS or an LP-WUS; and
an information of a first window, where the first window is configured to be used by the terminal to measure, by using the LP-WUR, the neighboring cell in the first window.

In a third aspect, an apparatus for measuring a cell is provided. The apparatus is applied to a terminal and includes:
a measurement module configured to measure a neighboring cell by using an LP-WUR.

In a fourth aspect, an apparatus for configuration is provided. The apparatus is applied to a network side device and includes:
a first sending module configured to send a first information or a second information to a terminal, where the first information is used for measuring a neighboring cell by using an LP-WUR, the second information is used for measuring the neighboring cell by using the LP-WUR, that is, the first information or the second information is used for configuring how to measure the neighboring cell by using the LP-WUR for the terminal; the first information includes at least one of the following: a first indication information corresponding to a first frequency point, where the first indication information is used for indicating whether to measure the first frequency point when the terminal measures the neighboring cell by using the LP-WUR; a second indication information corresponding to a first cell, where the second indication information is used for indicating whether to measure the first cell when the terminal measures the neighboring cell by using the LP-WUR; a third indication information corresponding to a second frequency point and a second cell, where the third indication information is used for indicating whether to measure the second frequency point and the second cell when the terminal measures the neighboring cell by using the LP-WUR; a frequency point information or a cell information, where the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and a SMTC information; and the second information includes at least one of the following: a fourth indication information, where the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell; a third information associated with a third frequency point, where the third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point; an information of a fourth cell associated with a third cell, where the information of the fourth cell is used for indicating that the third cell is synchronized with the fourth cell; a configuration information of an LP-SS or an LP-WUS; and an information of a first window, where the first window is configured to be used by the terminal to measure, by using the LP-WUR, the neighboring cell in the first window.

In a fifth aspect, a terminal is provided. The terminal includes a processor and a memory, where the memory stores a program or an instruction that is runnable on the processor, and the program or the instruction implements steps of the method in the first aspect when executed by the processor.

In a sixth aspect, a terminal is provided. The terminal includes a processor and a communication interface, where the processor measures a neighboring cell by using an LP-WUR.

In a seventh aspect, a network side device is provided. The network side device includes a processor and a memory, where the memory stores a program or an instruction that is runnable on the processor, and the program or the instruction implements steps of the method in the second aspect when executed by the processor.

In an eighth aspect, a network side device is provided. The network side device includes a processor and a communication interface, where the communication interface is configured to send a first information or a second information to a terminal, the first information is used for measuring a neighboring cell by using an LP-WUR, and the second information is used for measuring the neighboring cell by using the LP-WUR; the first information includes at least one of the following: a first indication information corresponding to a first frequency point, where the first indication information is used for indicating whether to measure the first frequency point when the terminal measures the neighboring cell by using the LP-WUR; a second indication information corresponding to a first cell, where the second indication information is used for indicating whether to measure the first cell when the terminal measures the neighboring cell by using the LP-WUR; a third indication information corresponding to a second frequency point and a second cell, where the third indication information is used for indicating whether to measure the second frequency point and the second cell when the terminal measures the neighboring cell by using the LP-WUR; a frequency point information or a cell information, where the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and a SMTC information; and the second information includes at least one of the following: a fourth indication information, where the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell; a third information associated with a third frequency point, where the third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point; an information of a fourth cell associated with a third cell, where the information of the fourth cell is used for indicating that the third cell is synchronized with the fourth cell; a configuration information of an LP-SS or an LP-WUS; and information of a first window, where the first window is configured to be used by the terminal to measure, by using the LP-WUR, the neighboring cell in the first window.

In a ninth aspect, a readable storage medium is provided. The readable storage medium stores a program or an instruction, where the program or the instruction implements steps of the method in the first aspect, or steps of the method in the second aspect when executed by a processor.

In a tenth aspect, a wireless communication system is provided. The wireless communication system includes a terminal and a network side device, where the terminal is configured to perform steps of the method in the first aspect, and the network side device is configured to perform steps of the method in the second aspect.

In an eleventh aspect, a chip is provided. The chip includes a processor and a communication interface, where the communication interface is coupled to the processor, and the processor is configured to run a program or an instruction to implement steps of the method in the first aspect, or steps of the method in the second aspect.

In a twelfth aspect, a computer program/program product is provided. The computer program/program product is stored in a storage medium, and the computer program/program product is executed by at least one processor to implement steps of the method in the first aspect, or steps of the method in the second aspect.

### BRIEF DESCRIPTION OF THE DRAWINGS

FIG. 1 is a block diagram of a wireless communication system applicable to an embodiment of the present disclosure;

FIG. 2 is a flowchart of a method for measuring a cell according to an embodiment of the present disclosure;

FIG. 3 is a flowchart of a method for configuration according to an embodiment of the present disclosure;

FIG. 4 is a schematic structural diagram of an apparatus for measuring a cell according to an embodiment of the present disclosure;

FIG. 5 is a schematic structural diagram of an apparatus for configuration according to an embodiment of the present disclosure;

FIG. 6 is a schematic structural diagram of a communication device according to an embodiment of the present disclosure;

FIG. 7 is a schematic structural diagram of a terminal according to an embodiment of the present disclosure; and

FIG. 8 is a schematic structural diagram of a network side device according to an embodiment of the present disclosure.

### DETAILED DESCRIPTION

Technical solutions in embodiments of the present disclosure will be clearly described below in conjunction with accompanying drawings in the embodiments of the present disclosure. Apparently, the embodiments described are some embodiments rather than all embodiments of the present disclosure. All other embodiments derived by those of ordinary skill in the art from the embodiments in the present disclosure should fall within the protection scope of the present disclosure.

Terms such as “first” and “second” in the present disclosure are used for distinguishing similar objects rather than describing a specific sequence or a sequential order. It should be understood that terms used in this way are interchangeable in appropriate cases, such that the embodiment of the present disclosure can be implemented in order other than those illustrated or described herein. In addition, the objects distinguished with “first” or “second” are usually objects of one class with the number of objects unlimited. For example, a first object can indicate one or more first objects. In addition, the term “or” in the present disclosure indicates at least one of connected objects. For example, “A or B” covers three solutions, that is, a solution 1 of including A and excluding B, a solution 2 of including B and excluding A, and solution 3 of including A and B. The character “/” generally indicates that the associated objects in the context have an “or” relationship.

The term “indication” in the present disclosure can be direct indication (or explicit indication), or may be indirect indication (or implicit indication). The direct indication can be understood as that a sender clearly informs a receiver of specific information, an operation to be performed, or a request result in the indication sent, and the indirect indication can be understood as that the receiver determines corresponding information according to the indication sent by the sender, or makes a decision and determines the operation to be executed or the request result according to a decision result.

It is worth noting that the technology described in the embodiment of the present disclosure is not limited to a long term evolution (Long Term Evolution, LTE)/LTE-advanced (LTE-Advanced, LTE-A) system, and may also be used in another wireless communication system, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA), or another system. The terms “system” and “network” in the embodiments of the present disclosure are often used interchangeably, and the technology described may be used for the systems and radio technologies mentioned above, or may be used for another system and radio technology. A new radio (New Radio, NR) system is illustratively described in the following description, and the term NR is used in most of the following description. However, these technologies may alternatively be applied to a system other than the NR system, such as a 6^{th} generation (6th Generation, 6G) communication system.

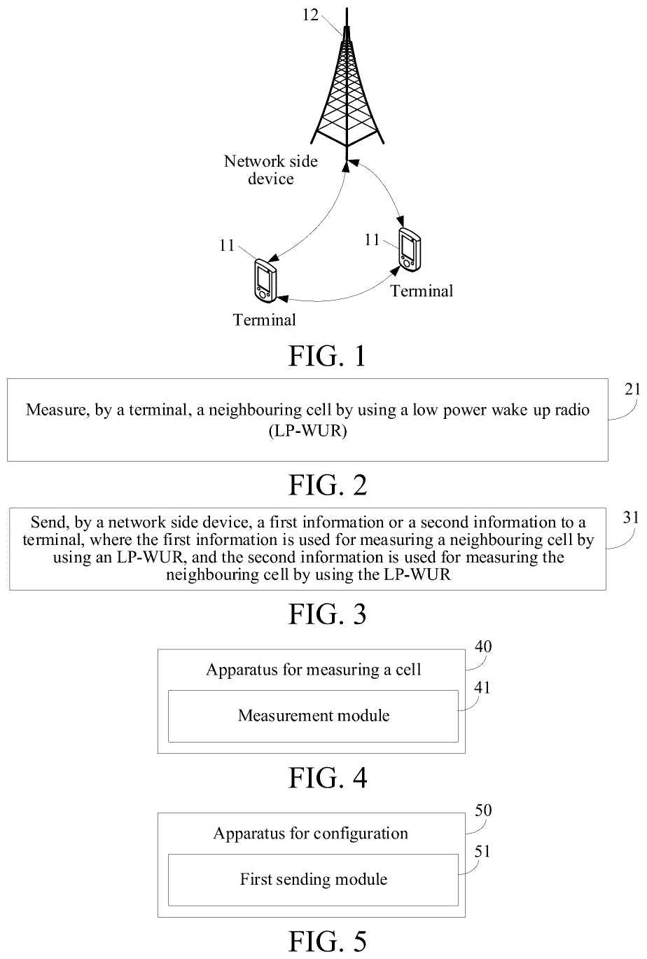

FIG. 1 shows a block diagram of a wireless communication system applicable to the embodiment of the present disclosure. The wireless communication system includes a terminal 11 and a network side device 12. The terminal 11 may be a mobile phone, a tablet personal computer (Tablet Personal Computer), a laptop computer (Laptop Computer), a notebook computer, a personal digital assistant (Personal Digital Assistant, PDA), a palmtop, a netbook, an ultra-mobile personal computer (Ultra-mobile Personal Computer, UMPC), a mobile Internet device (Mobile Internet Device, MID), an augmented reality (Augmented Reality, AR)/virtual reality (Virtual Reality, VR) device, a robot, a wearable device (Wearable Device), a flight vehicle (flight vehicle), vehicle user equipment (Vehicle User Equipment, VUE), a ship-borne device, pedestrian user equipment (Pedestrian User Equipment, PUE), a smart home (a house device with a wireless communication function, such as a refrigerator, a television, a washer, or a furniture), a game machine, a personal computer (Personal Computer, PC), an automated teller machine, or a self-service machine, and another terminal side device. The wearable device includes: a smart watch, a smart band, smart headphones, smart glasses, a smart jewelry (a smart bracelet, a smart hand chain, a smart ring, a smart necklace, a smart anklet, a smart ankle chain, etc.), a smart wristband, smart clothing, etc. The vehicle user equipment may alternatively be referred to as an in-vehicle terminal, an in-vehicle controller, an in-vehicle module, an in-vehicle component, an in-vehicle chip, or an in-vehicle unit. It should be noted that a specific type of the terminal 11 is not limited in the embodiment of the present disclosure. The network side device 12 may include an access network device or a core network device. The access network device may alternatively be referred to as a radio access network (Radio Access Network, RAN) device, a radio access network function, or a radio access network unit. The access network device may include a base station, a wireless local area network (Wireless Local Area Network, WLAN) access point (Access Point, AP), or a wireless fidelity (WiFi) node. The base station may be referred to as a node B (Node B, NB), an evolved node B (Evolved Node B, eNB), the next generation node B (the next generation Node B, gNB), a new radio node B (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home node B (home Node B, HNB), a home evolved node B (home evolved Node B), a transmission reception point (Transmission Reception Point, TRP), or another appropriate term in the field. As long as the same technical effect is achieved, the base station is not limited to a particular technical term. It should be noted that in the embodiment of the present disclosure, an introduction will be provided merely with the base station in the NR system as an example without being limited to a specific type of the base station.

In the embodiment of the present disclosure, the low power radio may alternatively be referred to as a low power wake up radio or an almost zero power wake up radio (Almost Zero Power Wake Up Radio, AZP-WUR), which is not limited.

In the embodiment of the present disclosure, a low power synchronization signal (Low Power Synchronization Signal, LP-SS) may alternatively be referred to as an almost zero power synchronization signal (Almost Zero Power Synchronization Signal, AZP-SS), etc. A low power wake up signal (Low Power Wake Up Signal, LP-WUS) may alternatively be referred to as an almost zero power wake up signal (Almost Zero Power Wake Up Signal, AZP-WUS).

How to measure the neighboring cell in a case that the LP-WUR is introduced is an urgent problem at present.

Embodiments of the present disclosure provide a method and apparatus for measuring a cell, a method and apparatus for configuration, a terminal, and a network side device, through which the problem of how to measure a neighboring cell in a case that a low power wake up radio (LP-WUR) is introduced can be solved.

A method and apparatus for measuring a cell, a method and apparatus for configuration, a terminal, and a network side device according to the embodiments of the present disclosure will be described in detail through some embodiments and their application scenarios and in conjunction with the accompanying drawings.

With reference to FIG. 2, FIG. 2 is a flowchart of the method for measuring a cell according to the embodiment of the present disclosure. The method is performed by a terminal. As shown in FIG. 2, the method includes:

Step 21: The terminal measures a neighboring cell by using an LP-WUR.

Herein, when the terminal measures the neighboring cell by using the LP-WUR, the LP-WUR may receive a reference signal (Reference Signal, RS) in the related art, or may not receive the RS in the related art, which is specifically related to a hardware capacity of the LP-WUR. The RS in related art includes, but is not limited to, a primary synchronization signal (Primary Synchronization Signal, PSS), a secondary synchronization signal (Secondary Synchronization Signal, SSS), a synchronization signal block (Synchronization Signal Block, SSB), a phase-tracking reference signal (Phase-Tracking Reference Signal, TRS), and a demodulation reference signal (DMRS).

The neighboring cell may be understood as a cell configured for the terminal, and the cell defaults to the neighboring cell by the terminal. But the neighboring cell is not necessarily a physically adjacent cell. In some scenarios, the neighboring cell may alternatively be referred to as a common frequency/different frequency cell other than a serving cell.

In some embodiments, measurement of the neighboring cell may be radio resource management (Radio Resource Management, RRM) measurement of the neighboring cell performed.

In some embodiments, the measurement of the neighboring cell may be measurement of the neighboring cell using the LP-SS or the LP-WUS, or the RS in the related art may be used for measuring the neighboring cell.

In this way, by using the LP-WUR to measure the neighboring cell, the problem of how to measure the neighboring cell in a case that the LP-WUR is introduced can be solved.

In the embodiment of the present disclosure, the step that a neighboring cell is measured by using an LP-WUR includes either of the following:
1) in a case that a first information is received by the terminal, the neighboring cell is measured by using the LP-WUR according to the first information; and
2) in a case that the first information is not received by the terminal, the neighboring cell is measured by using the LP-WUR according to a frequency point information or a cell information in a first system information block (System Information Block, SIB), and SSB measurement timing configuration (SSB Measurement Timing Configuration, SMTC) information. The SMTC information may be a SMTC information associated with a frequency point of a neighboring cell to be measured.

Optionally, the first information may be used for configuring how to measure the neighboring cell by using the LP-WUR for the terminal, and the first information may include at least one of the following:
a first indication information corresponding to a first frequency point, where the first indication information is used for indicating whether to measure the first frequency point when the terminal measures the neighboring cell by using the LP-WUR;
a second indication information corresponding to a first cell, where the second indication information is used for indicating whether to measure the first cell when the terminal measures the neighboring cell by using the LP-WUR;
a third indication information corresponding to a second frequency point and a second cell, where the third indication information is used for indicating whether to measure the second frequency point and the second cell when the terminal measures the neighboring cell by using the LP-WUR;
a frequency point information or a cell information, where the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and
the SMTC information.

It should be noted that the first information in the embodiment of the present disclosure may be used in combination with the frequency point information or the cell information in the first system information block (SIB) or the SMTC information. For example, frequency points corresponding to a frequency point information in a particular SIB includes a frequency point 1, a frequency point 2, and a frequency point 3. When the terminal measures the neighboring cell by using the LP-WUR, whether to measure the frequency point 1 may be indicated by the first indication information corresponding to the frequency point 1, whether to measure the frequency point 2 may be indicated by the first indication information corresponding to the frequency point 2, and whether to measure the frequency point 3 may be indicated by the first indication information corresponding to the frequency point 3. In addition, when the first indication information indicates that measurement is to be done, the LP-WUR is used for measuring a corresponding frequency point; otherwise, the LP-WUR is not used for measuring a corresponding frequency point. For example, cells corresponding to a cell information in a particular SIB include a cell 1, a cell 2 and a cell 3. When the terminal measures the neighboring cell by using the LP-WUR, whether to measure the cell 1 may be indicated by the second indication information corresponding to the cell 1, whether to measure the cell 2 may be indicated by the second indication information corresponding to the cell 2, and whether to measure the cell 3 may be indicated by the second indication information corresponding to the cell 3. In addition, when the second indication information indicates that measurement is to be done, the LP-WUR is used for measuring a corresponding cell; otherwise, the LP-WUR is not used for measuring a corresponding cell. For example, a frequency point information and a cell information in a particular SIB correspond to a frequency point 4 and a cell 4 as well as a frequency point 5 and a cell 5. When the terminal measures the neighboring cell by using the LP-WUR, whether to measure the frequency point 4 and the cell 4 may be indicated by the third indication information corresponding to the frequency point 4 and the cell 4, and whether to measure the frequency point 5 and the cell 5 may be indicated by the third indication information corresponding to the frequency point 5 and the cell 5. In addition, when the third indication information indicates that measurement is to be done, the LP-WUR is used for measuring a corresponding frequency point and cell; otherwise, the LP-WUR is not used for measuring a corresponding frequency point and cell.

In some embodiments, in a case that the LP-WUR may receive the RS in the related art, the first information may be introduced, and the frequency point or the cell measured by using LP-WUS as indicated by the first information is distinguished from a frequency point or a cell measured by a master radio (Master Radio, MR).

In some embodiments, a method for measuring the neighboring cell by using the LP-WUR may be decided according to whether to receive the first information. For example, if the first information is received, the neighboring cell is measured by using the LP-WUR according to the first information. If the first information is not received, the neighboring cell is measured by using the LP-WUR according to the frequency point information or the cell information in the first SIB and the SMTC information.

In some embodiments, when the SMTC information is not included in the first information, the neighboring cell may be measured by using the SMTC information in the first SIB.

Optionally, the first SIB may include at least one of the following: an SIB 2, an SIB 3, an SIB 4, and an SIB 5. For example, if the SIB 2 is adopted, a common frequency neighboring cell is measured according to a SMTC information configured in the SIB 2. If the SIB 3 is adopted, measurement is performed according to a list information of common frequency cells in the SIB 3. If the SIB 4 is adopted, measurement is performed according to a frequency point information and a cell information in the SIB 4. If the SIB 5 is adopted, measurement is performed according to a frequency point information and a cell information in the SIB 5.

Optionally, the step that the neighboring cell is measured by using the LP-WUR according to the first information may include: the terminal measures the neighboring cell according to the first information and the information in the first SIB by using the LP-WUR in an SMTC window. The SMTC may be SMTC in the related art in a current SIB 2/SIB 4, or may be newly defined SMTC, which is not limited. In this way, the neighboring cell can be measured by comprehensively considering the configured first information and first SIB, and the neighboring cell can be measured accurately by using the LP-WUR.

For example, if the first information includes the frequency point, the cell information, and the SMTC information, the terminal may merely use the first information to measure the neighboring cell after determining a neighboring cell information measured by using the LP-WUR according to the first information. For example, the neighboring cell is measured in the SMTC window indicated by the SMTC information in the first information.

For example, if the first information includes the first indication information, the second indication information, or the third indication information, the terminal may measure the neighboring cell in the SMTC window indicated by the first SIB after determining a neighboring cell information measured by using the LP-WUR according to the first information and the frequency point/the cell information in the first SIB.

For example, if the first information includes the first indication information, the second indication information, or the third indication information, and the first information includes the SMTC information, the terminal may measure the neighboring cell in the SMTC window indicated by the SMTC information included in the first information after determining a neighboring cell information measured by using the LP-WUR according to the first information as well as the frequency point and the cell information in the first SIB.

For example, if the first information includes the frequency point and the cell information, the terminal may measure the neighboring cell in the SMTC window indicated by the first SIB after determining a neighboring cell information measured by using the LP-WUR according to the first information.

Optionally, the step that a neighboring cell is measured by using an LP-WUR may include:
in a case that a first condition is satisfied, the terminal measures wireless link quality of the neighboring cell by using the LP-WUR according to information in a first SIB. The first condition includes at least one of the following:
when a master radio (MR) is in an ultra-deep sleep state (ultra-deep sleep state), the terminal stores effective system information or is capable of measuring the neighboring cell (that is, has a capacity for measuring the neighboring cell); and
when in an ultra-deep sleep state (ultra-deep sleep state), the terminal stores effective system information or is capable of measuring the neighboring cell.

Storage of the effective system information may be understood as maintaining the system information, that is, storing the system information, and receiving new system information when the system information is to be updated.

In some embodiments, the first condition may be determined through network indication, predetermination, or protocol agreement.

In some embodiments, if the first condition is determined through the network indication or the protocol agreement, and the LP-WUR of the terminal may receive the RS (such as the PSS/the SSS/the SSB/the TRS/the DMRS) in the related art, the terminal may measure the wireless link quality of the neighboring cell by using the LP-WUR based on the current SIB 2/SIB 3/SIB 4/SIB 5 when a neighboring cell assessment condition is satisfied in a case that the terminal/the MR is in the ultra-deep sleep state; otherwise, the terminal does not measure the neighboring cell.

In the embodiment of the present disclosure, since accuracy of measurement by using the LP-WUR is poor, an offset value can be introduced to compensate for a measurement result of the LP-WUR, and accuracy of the measurement result can be improved.

Optionally, the method for measuring a cell may further include:
the terminal obtains a first offset value, the first offset value is used for compensating for a cell measurement result of measurement by using the LP-WUR, such that a final cell measurement result of the measurement by using the LP-WUR is obtained.

In some embodiments, the first offset value may be a positive value, that is, for increasing the cell measurement result, or a negative value, that is, for decreasing the cell measurement result.

In some embodiments, a unit of the first offset value may be either of decibel (dB) and decibel-milliwatts (dBm).

In some embodiments, the terminal may obtain the first offset value based on the network indication, the predetermination, the protocol agreement, etc.

In some embodiments, the cell measurement result measured by using the LP-WUR may include a measurement of the serving cell and a measurement of the neighboring cell. The measurement may include, but is not limited to, a reference signal received power (Reference Signal Received Power, RSRP), and reference signal received quality (Reference Signal Received Quality, RSRQ).

In some embodiments, the first offset value is associated with a specific frequency point, that is, compensation is merely performed for a measurement result of a cell under the specific frequency point according to the first offset value. Or, the first offset value is associated with a specific cell, that is, compensation is merely performed for a measurement result of the specific cell according to the first offset value. Or, the first offset value is associated with a specific frequency point and a specific cell, that is, compensation is merely performed for measurement results of the specific frequency point and the specific cell according to the first offset value.

Optionally, the step that a neighboring cell is measured by using an LP-WUR may include:
in a case that a second condition is satisfied, the terminal measures the neighboring cell by using the LP-WUR. The second condition includes at least one of the following:
a measurement result of the serving cell obtained by using the master radio or the low power wake up radio is lower than or equal to a first threshold. It can be understood that if the measurement result of the serving cell is lower than or equal to the first threshold, wireless link quality of the serving cell is deteriorated, and the serving cell is no longer suitable for long-term residence of the terminal. Thus, the terminal needs to measure the neighboring cell to search for a more suitable residence cell; and
a measurement result of the neighboring cell obtained by using the master radio is higher than or equal to a second threshold. It can be understood that if the master radio may measure the neighboring cell, and measured quality of the neighboring cell is higher than or equal to the second threshold, some neighboring cells may become suitable residence cells. In this case, the terminal merely performs supplementary measurement of the neighboring cell by using the LP-WUR.

In this way, in virtue of restriction from the second condition, the LP-WUR of the terminal is not to measure the neighboring cell all the time, and the measurement of the neighboring cell is merely started under a particular condition. Thus, measurement complexity is reduced.

It should be noted that the first threshold and the second threshold may be set based on actual demand. The measurement result of the serving cell includes at least one of the following: a layer 3 measurement result obtained through measurement of the SSB by the master radio, a layer 3 measurement result obtained through measurement of the SSB by the low power wake up radio, and a measurement result obtained through measurement of the LP-SS or the LP-WUS by the low power wake up radio. The measurement result includes, but is not limited to, the RSRP and RSRQ.

In the embodiment of the present disclosure, the method for measuring a cell further includes:
the terminal obtains a second information. The second information may be used for configuring how to measure the neighboring cell by using the LP-WUR for the terminal. For example, the terminal may receive the second information from the network side device.

Optionally, the step that a neighboring cell is measured by using an LP-WUR includes any one of the following:
the terminal measures the neighboring cell by using the LP-WUR according to the second information. The second information includes, but is not limited to, at least one of the following:
(1) a fourth indication information, where the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell.

Herein, the fourth indication information may be directed at a single terminal, that is, the fourth indication information is per UE. In this case, the fourth indication information is used for indicating whether all the neighboring cells measured by the terminal using the LP-WUR are synchronized with the serving cell, or indicating whether all the neighboring cells measured by the terminal using the LP-WUR are synchronized. The fourth indication information may alternatively be directed at a single frequency, that is, the fourth indication information is per frequency. In this case, the fourth indication information is used for indicating whether the common frequency neighboring cell measured by the terminal using LP-WUR is synchronized with the serving cell, or indicating whether different frequency points are synchronized.

Regarding whether to synchronize with the serving cell, it can be understood that the terminal may directly perform measurement according to RS configuration of the neighboring cell without using the SMTC window or the first window in a case of synchronization, and the terminal may directly measure the neighboring cell without precise synchronization with the neighboring cell in a case of the synchronization. In a case of non-synchronization, the terminal is to synchronize with the neighboring cell at first, and then performs measurement according to the RS configuration; otherwise the RS configuration provided by the serving cell may be offset. The terminal may measure the neighboring cell in the first window or the SMTC window in a case of the non-synchronization.

(2) A third information associated with a third frequency point. The third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point.

Herein, when the cells associated with the third frequency point are synchronized with the cells associated with the fourth frequency point, the cells associated with the third frequency point are synchronized, and the cells associated with the fourth frequency point are synchronized.

In some embodiments, when the second information includes the fourth indication information, and the fourth indication information is per frequency, the fifth indication information is to be introduced for another frequency point, such as the third frequency point, to indicate whether the cells associated with the third frequency point are synchronized.

In some embodiments, when the third frequency point is configured, the information of the fourth frequency point may be added/set at an associated position of the third frequency point, to indicate that the cell associated with the third frequency point is synchronized with the cell associated with the fourth frequency point.

(3) An information of a fourth cell associated with a third cell. The information of the fourth cell is used for indicating that the third cell is synchronized with the fourth cell.

In some embodiments, when the third cell is configured, the information of the fourth cell may be added/set at an associated position of the third cell, to indicate that the third cell is synchronized with the fourth cell.

(4) A configuration information of an LP-SS or an LP-WUS. Herein, the configuration information of the LP-SS may be merely included, the configuration information of the LP-WUS may be merely included, or the configuration information of the LP-SS and the configuration information of the LP-WUS may be included.

(5) An information of a first window. The first window is configured to be used by the terminal to measure, by using the LP-WUR, the neighboring cell in the first window. The first window may be understood as the measurement window of the LP-SS/the LP-WUS.

In some embodiments, the second information may be introduced in a case that the LP-WUR may not receive the RS in the related art, and the neighboring cell may be measured by using the LP-WUS according to the second information. The RS in the related art includes, but is not limited to, the PSS, the SSS, the SSB, the TRS, and the DMRS.

Optionally, the configuration information of the LP-SS or the configuration information of the LP-WUS includes the configuration information of the LP-SS or the configuration information of the LP-WUS of the cell associated with the terminal. The configuration information may include, but is not limited to, at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
a monitoring duration of the LP-SS or the LP-WUS of the cell associated with the terminal; and
a monitoring time window of the LP-SS or the LP-WUS of the cell associated with the terminal.

In this way, in virtue of the configuration information of the LP-SS or the LP-WUS of the cell associated with the terminal, the terminal can measure the neighboring cell by accurately using the LP-SS or the LP-WUS.

In some embodiments, the cells associated with the terminal includes the serving cell and the neighboring cell.

In some embodiments, the cells associated with the terminal include all cells within a mobility range of the terminal. The mobility range of the terminal may include at least one of the following: a tracking area of the terminal, a notification area of a wireless access network of the terminal, and an area of another protocol agreement or network configuration.

Optionally, the information of the first window includes, but is not limited to, at least one of the following:
a cycle of the first window;
an initial position of the cycle of the first window;
an initial offset of the cycle of the first window; and
duration of the first window.

In this way, in virtue of the information of the first window, a position of the first window can be accurately determined, thereby improving accuracy of measurement of the neighboring cell in the first window.

Optionally, the first window may be related to/associated with the frequency point, the cell, or the terminal. When the second information includes the information of the first window, the step that the neighboring cell is measured by using the LP-WUR according to the second information may include at least one of the following:
in a case that the first window is associated with a fifth frequency point, the terminal measures a cell associated with the fifth frequency point in the first window by using the LP-WUR according to the information of the first window. For example, when the first window is associated with one frequency point, the terminal measures the frequency point in the first window, and in this case, the information of the first window is to be introduced for another frequency point;
in a case that the first window is associated with a fifth cell, the terminal measures the fifth cell in the first window by using the LP-WUR according to the information of the first window. For example, when the first window is associated with one cell, the terminal measures the cell in the first window, and in this case, the information of the first window is to be introduced for each cell to be measured; and
in a case that the first window is associated with the terminal, the terminal measures a neighboring cell associated with the terminal in the first window by using the LP-WUR according to the information of the first window. For example, when the first window is associated with the terminal, the terminal measures all the neighboring cells in the first window, and merely one information window need to be introduced in this case.

In some embodiments, in a case that the second information includes the information of the first window, the configuration information of the LP-SSes or the LP-WUSes of the serving cell and the neighboring cell may not be included in the second information, but the neighboring cell may be measured according to the information of the first window.

It should be noted that in a case that the second information configured by the network side device for the terminal includes the configuration information of the LP-SS or the LP-WUS, if the network side device determines that all the neighboring cells of the terminal are synchronized with the serving cell, the network side device does not configure the information of the first window for the terminal since the measurement may be performed without using the first window in a case of synchronization.

Optionally, the step that the neighboring cell is measured by using the LP-WUR according to the second information may include:
in a case that a third condition is satisfied, the terminal measures the neighboring cell by using the LP-WUR according to the second information. The third condition includes at least one of the following:
when a master radio (MR) is in an ultra-deep sleep state (ultra-deep sleep state), the terminal is capable of measuring the neighboring cell; and
when in an ultra-deep sleep state (ultra-deep sleep state), the terminal is capable of measuring the neighboring cell.

In some embodiments, the third condition may be determined through network indication, predetermination, or protocol agreement.

In some embodiments, if the third condition is determined through the network indication or the protocol agreement, and the LP-WUR of the terminal may not receive the RS (such as the PSS/the SSS/the SSB/the TRS/the DMRS) in the related art, the terminal may measure the neighboring cell based on the received second information when an assessment condition (such as the second condition mentioned above) of the measurement of the neighboring cell is satisfied in a case that the terminal/the MR is in the ultra-deep sleep state.

In the embodiment of the present disclosure, if the LP-SS or the LP-WUS is configured for a single cell (that is, per cell), a configuration information of all the cells to be measured can be obtained based on a configuration information of a reference cell and correlation (for example, the correlation between time domain positions) between different cells. Thus, configuration signaling overhead is reduced.

Optionally, the method for measuring a cell further includes:
the terminal obtains fourth information. The fourth information includes that time domain positions of the LP-SSes or the LP-WUSes between cells associated with the terminal are related. For example, the cells associated with the terminal include the serving cell and the neighboring cell, or the cells associated with the terminal include all cells within a mobility range of the terminal. The mobility range of the terminal includes at least one of the following: a tracking area of the terminal, a notification area of a wireless access network of the terminal, and an area of another protocol agreement or network configuration.

In some embodiments, the fourth information may be determined through network indication, predetermination, or protocol agreement.

Optionally, the fourth information may include either of the following:
the time domain positions of the LP-SSes or the LP-WUSes between the cells associated with the terminal are the same; and
a first time domain position and a second time domain position are separated by N times a second offset value or a third offset value. Specifically, N is an integer greater than or equal to 1, the first time domain position is a time domain position of an LP-SS or an LP-WUS of a seventh cell, the second time domain position is a time domain position of an LP-SS or an LP-WUS of a sixth cell, and the second time domain position is used for determining a time domain position of an LP-SS or an LP-WUS of another cell in the cells associated with the terminal except the sixth cell. Herein, the sixth cell may be understood as the reference cell, and the terminal determines the time domain position of the LP-SS or the LP-WUS of another cell (such as the seventh cell) according to the time domain position and an offset information of the LP-SS or the LP-WUS of the sixth cell. The seventh cell may be understood as one or more cells in the cells associated with the terminal except the sixth cell, and the time domain position of the LP-SS or the LP-WUS is determined according to the time domain position of the LP-SS or the LP-WUS of the sixth cell, rather than is not directly configured.

In this way, by configuring the time domain position of the LP-SS or the LP-WUS of a particular cell (such as the serving cell), the time domain position of the LP-SS or the LP-WUS of the another cell may be directly obtained, but the time domain position of the LP-SS or the LP-WUS of the another cell is no longer configured. Thus, the configuration signaling overhead is reduced.

In some embodiments, a unit of the second offset value or the third offset value may be any one of a second, a millisecond, a system frame number (System Frame Number, SFN), a subframe, a slot, and an orthogonal frequency division multiplexing (OFDM) symbol.

In some embodiments, the second offset value or the third offset value may be a positive value or a negative value.

In some embodiments, the second offset value or the third offset value may be obtained based on the network indication, the predetermination, the protocol agreement, etc.

In some embodiments, the sixth cell and the seventh cell are located in a same object. That is, the time domain positions of the LP-SSes or LP-WUSes of the sixth cell and the seventh cell that are in the same object are separated by N times the second offset value or the third offset value. The object may include, but is not limited to, the frequency point and a target areas. The target area is, for example, the tracking area of the terminal, the notification area of the wireless access network of the terminal, and the area of another protocol agreement or network configuration.

Optionally, in a case that the fourth information is obtained, the configuration information of the LP-SS or the LP-WUS may include the time domain position (that is, the second time position) of the LP-SS or the LP-WUS of the sixth cell and a configuration information of the seventh cell, and the configuration information of the seventh cell includes at least one of the following:
the second offset value. The second offset value is used for indicating an offset value between the time domain positions of the LP-SSes or the LP-WUSes of the sixth cell and the seventh cell;
the third offset value or the positive integer N. The third offset value or the positive integer N is used for indicating that the time domain positions of the LP-SSes or the LP-WUSes of the sixth cell and the seventh cell are separated by N times the third offset value. For example, the network may configure the third offset value and the positive integer N. Or, the network may configure the third offset value, and the positive integer N value may be determined through the predetermination or the protocol agreement. Or, the network may configure the positive integer N value, and the third offset value may be determined through the predetermination or the protocol agreement; and
a seventh indication information. The seventh indication information is used for indicating that the time domain position of the LP-SS or the LP-WUS of the seventh cell is positively offset or negatively offset relative to the time domain position of the LP-SS or the LP-WUS of the sixth cell, so as to adjust the time domain position of the LP-SS or the LP-WUS in the sixth cell forwards or backwards. Thus, the time domain position of the LP-SS or the LP-WUS in the seventh cell can be determined accurately.

With reference to FIG. 3, FIG. 3 is a flowchart of a method for configuration according to the embodiment of the present disclosure. The method is performed by a network side device. As shown in FIG. 3, the method includes:

Step 31: The network side device sends a first information or a second information to a terminal. The first information is used for measuring a neighboring cell by using an LP-WUR, and the second information is used for measuring the neighboring cell by using the LP-WUR.

Herein, the first information may be used for configuring how to measure the neighboring cell by using the LP-WUR for the terminal, and the first information includes at least one of the following:
a first indication information corresponding to a first frequency point. The first indication information is used for indicating whether to measure the first frequency point when the terminal measures the neighboring cell by using the LP-WUR;
a second indication information corresponding to a first cell. The second indication information is used for indicating whether to measure the first cell when the terminal measures the neighboring cell by using the LP-WUR;
a third indication information corresponding to a second frequency point and a second cell. The third indication information is used for indicating whether to measure the second frequency point and the second cell when the terminal measures the neighboring cell by using the LP-WUR;
a frequency point information or a cell information. The frequency point information is used for indicating that a frequency point corresponding to the frequency point information need be measured when the terminal measures the neighboring cell by using the LP-WUR, and the cell information is used for indicating that a cell corresponding to the cell information need to be measured when the terminal measures the neighboring cell by using the LP-WUR; and
a SMTC information.

Optionally, the second information may be used for configuring how to measure the neighboring cell by using the LP-WUR for the terminal, and the second information includes at least one of the following:
a fourth indication information. The fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point. The third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point;
an information of a fourth cell associated with a third cell. The information of the fourth cell is used for indicating that the third cell is synchronized with the fourth cell;
a configuration information of an LP-SS or an LP-WUS; and
an information of a first window, where the first window is configured to be used by the terminal to measure, by using the LP-WUR, the neighboring cell in the first window.

Optionally, when the terminal measures the neighboring cell by using the LP-WUR, and the LP-WUR may receive an RS in the related art, or may not receive the RS in the related art. The RS in the related art includes, but is not limited to, a PSS, an SSS, an SSB, a TRS, and a DMRS.

In this way, the terminal can measure the neighboring cell by using the LP-WUR, thus solving the problem of how to measure the neighboring cell in a case that the LP-WUR is introduced.

Optionally, the information of the first window includes at least one of the following:
a cycle of the first window;
an initial position of the cycle of the first window;
an initial offset of the cycle of the first window; and
duration of the first window.

Optionally, the first window is associated with a fifth frequency point, and the information of the first window is used for measuring a cell associated with the fifth frequency point in the first window by using the LP-WUR.

Or, the first window is associated with a fifth cell, and the information of the first window is used for measuring the fifth cell in the first window by using the LP-WUR.

Or, the first window is associated with the terminal, and the information of the first window is used for measuring a neighboring cell associated with the terminal in the first window by using the LP-WUR.

Optionally, the configuration information of the LP-SS or the LP-WUS includes a configuration information of an LP-SS or an LP-WUS of a cell associated with the terminal.

The configuration information of the LP-SS or the LP-WUS of the cell associated with the terminal includes at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
monitoring duration of the LP-SS or the LP-WUS of the cell associated with the terminal; and
a monitoring time window of the LP-SS or the LP-WUS of the cell associated with the terminal.

Optionally, the method for configuration further includes:
the network side device sends an eighth indication information to the terminal.

The eighth indication information is used for indicating that time domain positions of LP-SSes or LP-WUSes between cells associated with the terminal are related.

Optionally, the eighth indication information is used for indicating either of the following:
the time domain positions of the LP-SSes or the LP-WUSes between the cells associated with the terminal are the same; and
a first time domain position and a second time domain position are separated by N times a second offset value or a third offset value. Specifically, N is an integer greater than or equal to 1, the first time domain position is a time domain position of an LP-SS or an LP-WUS of a seventh cell, the second time domain position is a time domain position of an LP-SS or an LP-WUS of a sixth cell, and the second time domain position is used for determining a time domain position of an LP-SS or an LP-WUS of another cell in the cells associated with the terminal except the sixth cell.

Optionally, the sixth cell and the seventh cell are located in a same object.

Optionally, the configuration information of the LP-SS or the LP-WUS includes the time domain position of the LP-SS or the LP-WUS of the sixth cell and a configuration information of the seventh cell, and the configuration information of the seventh cell includes at least one of the following:
the second offset value;
the third offset value or the N; and
a seventh indication information. The seventh indication information is used for indicating that the time domain position of the LP-SS or the LP-WUS of the seventh cell is positively offset or negatively offset relative to the time domain position of the LP-SS or the LP-WUS of the sixth cell.

Optionally, the method for configuration further includes:
the network side device sends a ninth indication information to the terminal. The ninth indication information is used for indicating at least one of the following:
when a master radio is in an ultra-deep sleep state, the terminal stores effective system information or is capable of measuring the neighboring cell; and
when in an ultra-deep sleep state, the terminal stores effective system information or is capable of measuring the neighboring cell.

A performing subject of the method for measuring a cell according to the embodiment of the present disclosure may be an apparatus for measuring a cell. In the embodiment of the present disclosure, the apparatus for measuring a cell according to the embodiment of the present disclosure is described with the apparatus for measuring a cell performing the method for measuring a cell as an example.

With reference to FIG. 4, FIG. 4 is a schematic structural diagram of an apparatus for measuring a cell according to an embodiment of the present disclosure. The apparatus is applied to a terminal. As shown in FIG. 4, the apparatus 40 for measuring a cell includes:
a measurement module 41 configured to measure a neighboring cell by using a low power wake up radio (LP-WUR).

Optionally, the measurement module 41 is specifically configured to perform either of the following:
measure, in a case that a first information is received, the neighboring cell by using the LP-WUR according to the first information; and
measure, in a case that the first information is not received, the neighboring cell by using the LP-WUR according to a frequency point information or a cell information in a first SIB, and synchronization signal block (SSB) measurement timing configuration (SMTC) information.

The first information includes at least one of the following:
a first indication information corresponding to a first frequency point. The first indication information is used for indicating whether to measure the first frequency point when the terminal measures the neighboring cell by using the LP-WUR;
a second indication information corresponding to a first cell. The second indication information is used for indicating whether to measure the first cell when the terminal measures the neighboring cell by using the LP-WUR;
a third indication information corresponding to a second frequency point and a second cell. The third indication information is used for indicating whether to measure the second frequency point and the second cell when the terminal measures the neighboring cell by using the LP-WUR;
a frequency point information or a cell information. The frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and
the SMTC information.

Optionally, the measurement module 41 is specifically configured to measure the neighboring cell according to the first information and the information in the first SIB by using the LP-WUR in an SMTC window.

Optionally, the measurement module 41 is specifically configured to:
measure, in a case that a first condition is satisfied, wireless link quality of the neighboring cell by using the LP-WUR according to information in a first SIB. The first condition includes at least one of the following:
when a master radio is in an ultra-deep sleep state, the terminal stores effective system information or is capable of measuring the neighboring cell; and
when in an ultra-deep sleep state, the terminal stores effective system information or is capable of measuring the neighboring cell.

Optionally, the first SIB includes at least one of the following:
an SIB 2, an SIB 3, an SIB 4, and an SIB 5.

Optionally, the apparatus 40 for measuring a cell further includes:
a first obtainment module configured to obtaining a first offset value. The first offset value is used for compensating for a cell measurement result of measurement by using the LP-WUR.

Optionally, the first offset value is associated with a specific frequency point, or the first offset value is associated with a specific cell.

Optionally, the measurement module 41 is specifically configured to measure, in a case that a second condition is satisfied, the neighboring cell by using the LP-WUR according to the second information. The second condition includes at least one of the following:
a measurement result of a serving cell obtained by using the master radio or the low power wake up radio is lower than or equal to a first threshold; and
a measurement result of the neighboring cell obtained by using the master radio is higher than or equal to a second threshold.

Optionally, the apparatus 40 for measuring a cell further includes:
a second obtainment module configured to obtain a second information. The second information may be used for configuring how to measure the neighboring cell by using the LP-WUR for the terminal.

The measurement module 41 is specifically configured to measure the neighboring cell by using the LP-WUR according to the second information. The second information includes at least one of the following:
a fourth indication information. The fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point. The third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point;
an information of a fourth cell associated with a third cell. The information of the fourth cell is used for indicating that the third cell is synchronized with the fourth cell;
a configuration information of a low power synchronization signal (LP-SS) or a low power wake up signal (LP-WUS); and
an information of a first window. The first window is configured to be used by the terminal to measure, by using the LP-WUR, the neighboring cell in the first window.

Optionally, the information of the first window includes at least one of the following:
a cycle of the first window;
an initial position of the cycle of the first window;
an initial offset of the cycle of the first window; and
duration of the first window.

Optionally, when the second information includes the information of the first window, the measurement module 41 is specifically configured to perform at least one of the following:
measure, in a case that the first window is associated with a fifth frequency point, a cell associated with the fifth frequency point in the first window by using the LP-WUR according to the information of the first window;
measure, in a case that the first window is associated with a fifth cell, the fifth cell in the first window by using the LP-WUR according to the information of the first window; and
measure, in a case that the first window is associated with the terminal, a neighboring cell associated with the terminal in the first window by using the LP-WUR according to the information of the first window.

Optionally, the configuration information of the LP-SS or the LP-WUS includes a configuration information of an LP-SS or an LP-WUS of a cell associated with the terminal. The configuration information includes at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
monitoring duration of the LP-SS or the LP-WUS of the cell associated with the terminal; and
a monitoring time window of the LP-SS or the LP-WUS of the cell associated with the terminal.

Optionally, the apparatus 40 for measuring a cell further includes:
a third obtainment module configured to obtain fourth information. The fourth information includes that time domain positions of LP-SSes or LP-WUSes between cells associated with the terminal are related.

Optionally, the fourth information includes either of the following:
the time domain positions of the LP-SSes or the LP-WUSes between the cells associated with the terminal are the same; and
a first time domain position and a second time domain position are separated by N times a second offset value or a third offset value. Specifically, N is an integer greater than or equal to 1, the first time domain position is a time domain position of an LP-SS or an LP-WUS of a seventh cell, the second time domain position is a time domain position of an LP-SS or an LP-WUS of a sixth cell, and the second time domain position is used for determining a time domain position of an LP-SS or an LP-WUS of another cell in the cells associated with the terminal except the sixth cell.

Optionally, the sixth cell and the seventh cell are located in a same object.

Optionally, the configuration information of the LP-SS or the low power wake up signal (LP-WUS) includes the time domain position of the LP-SS or the LP-WUS of the sixth cell and a configuration information of the seventh cell, and the configuration information of the seventh cell includes at least one of the following:
the second offset value;
the third offset value or the N; and
a seventh indication information. The seventh indication information is used for indicating that the time domain position of the LP-SS or the LP-WUS of the seventh cell is positively offset or negatively offset relative to the time domain position of the LP-SS or the LP-WUS of the sixth cell.

Optionally, the measurement module 41 is specifically configured to measure, in a case that a third condition is satisfied, the neighboring cell by using the LP-WUR according to the second information. The third condition includes at least one of the following:
when a master radio is in an ultra-deep sleep state, the terminal is capable of measuring the neighboring cell; and
when in an ultra-deep sleep state, the terminal is capable of measuring the neighboring cell.

The apparatus 40 for measuring a cell in the embodiment of the present disclosure may be an electronic device, such as an electronic device having an operating system, or a component in the electronic device, such as an integrated circuit or a chip. The electronic device may be a terminal or another device except the terminal. Illustratively, the terminal may include, but is not limited to, the types of the terminal 11 listed above, and another device may be a server, a network attached storage (Network Attached Storage, NAS), etc., which is not specifically limited in the embodiment of the present disclosure.

The apparatus 40 for measuring a cell according to the embodiment of the present disclosure can implement processes implemented by the embodiment of the method of FIG. 2, and achieve the same technical effect, which is not repeated herein for avoiding repetition.

With reference to FIG. 5, FIG. 5 is a schematic structural diagram of an apparatus for configuration according to an embodiment of the present disclosure. The apparatus is applied to a network side device. As shown in FIG. 5, the apparatus 50 for configuration includes:
a first sending module 51 configured to send a first information or a second information to a terminal. The first information is used for measuring a neighboring cell by using an LP-WUR, and the second information is used for measuring the neighboring cell by using the LP-WUR.

Herein, the first information includes at least one of the following:
a first indication information corresponding to a first frequency point. The first indication information is used for indicating whether to measure the first frequency point when the terminal measures the neighboring cell by using the LP-WUR;
a second indication information corresponding to a first cell. The second indication information is used for indicating whether to measure the first cell when the terminal measures the neighboring cell by using the LP-WUR;
a third indication information corresponding to a second frequency point and a second cell. The third indication information is used for indicating whether to measure the second frequency point and the second cell when the terminal measures the neighboring cell by using the LP-WUR;
a frequency point information or a cell information. The frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and
a SMTC information.

Herein, the second information includes at least one of the following:
a fourth indication information. The fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point. The third information includes at least one of the following: a fifth indication information and an information of a fourth frequency point, the fifth indication information is used for indicating whether cells associated with the third frequency point are synchronized, and the information of the fourth frequency point is used for indicating that the cells associated with the third frequency point are synchronized with a cell associated with the fourth frequency point;
an information of a fourth cell associated with a third cell. The information of the fourth cell is used for indicating that the third cell is synchronized with the fourth cell;
a configuration information of an LP-SS or an LP-WUS; and
an information of a first window. The first window is configured to be used by the terminal to measure, by using the LP-WUR, the neighboring cell in the first window.

Optionally, the information of the first window includes at least one of the following:
a cycle of the first window;
an initial position of the cycle of the first window;
an initial offset of the cycle of the first window; and
duration of the first window.

Optionally, the first window is associated with a fifth frequency point, and the information of the first window is used for measuring a cell associated with the fifth frequency point in the first window by using the LP-WUR.

Or, the first window is associated with a fifth cell, and the information of the first window is used for measuring the fifth cell in the first window by using the LP-WUR.

Or, the first window is associated with the terminal, and the information of the first window is used for measuring a neighboring cell associated with the terminal in the first window by using the LP-WUR.

Optionally, the configuration information of the LP-SS or the LP-WUS includes a configuration information of an LP-SS or an LP-WUS of a cell associated with the terminal. The configuration information includes at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
monitoring duration of the LP-SS or the LP-WUS of the cell associated with the terminal; and
a monitoring time window of the LP-SS or the LP-WUS of the cell associated with the terminal.

Optionally, the apparatus 50 for configuration further includes:
a second sending module configured to send an eighth indication information to the terminal. The eighth indication information is used for indicating that time domain positions of LP-SSes or LP-WUSes between cells associated with the terminal are related.

Optionally, the eighth indication information is used for indicating either of the following:
the time domain positions of the LP-SSes or the LP-WUSes between the cells associated with the terminal are the same; and
a first time domain position and a second time domain position are separated by N times a second offset value or a third offset value. Specifically, N is an integer greater than or equal to 1, the first time domain position is a time domain position of an LP-SS or an LP-WUS of a seventh cell, the second time domain position is a time domain position of an LP-SS or an LP-WUS of a sixth cell, and the second time domain position is used for determining a time domain position of an LP-SS or an LP-WUS of another cell in the cells associated with the terminal except the sixth cell.

Optionally, the sixth cell and the seventh cell are located in a same object.

Optionally, the configuration information of the LP-SS or the LP-WUS includes the time domain position of the LP-SS or the LP-WUS of the sixth cell and a configuration information of the seventh cell, and the configuration information of the seventh cell includes at least one of the following:
the second offset value;
the third offset value or the N; and
a seventh indication information. The seventh indication information is used for indicating that the time domain position of the LP-SS or the LP-WUS of the seventh cell is positively offset or negatively offset relative to the time domain position of the LP-SS or the LP-WUS of the sixth cell.

Optionally, the apparatus 50 for configuration further includes:
a third sending module configured to send a ninth indication information to the terminal. The ninth indication information is used for indicating at least one of the following:
when a master radio is in an ultra-deep sleep state, the terminal stores effective system information or is capable of measuring the neighboring cell; and
when in an ultra-deep sleep state, the terminal stores effective system information or is capable of measuring the neighboring cell.

The apparatus 50 for configuration according to the embodiment of the present disclosure can implement processes implemented by the embodiment of the method of FIG. 3, and achieve the same technical effect, which is not repeated herein for avoiding repetition.

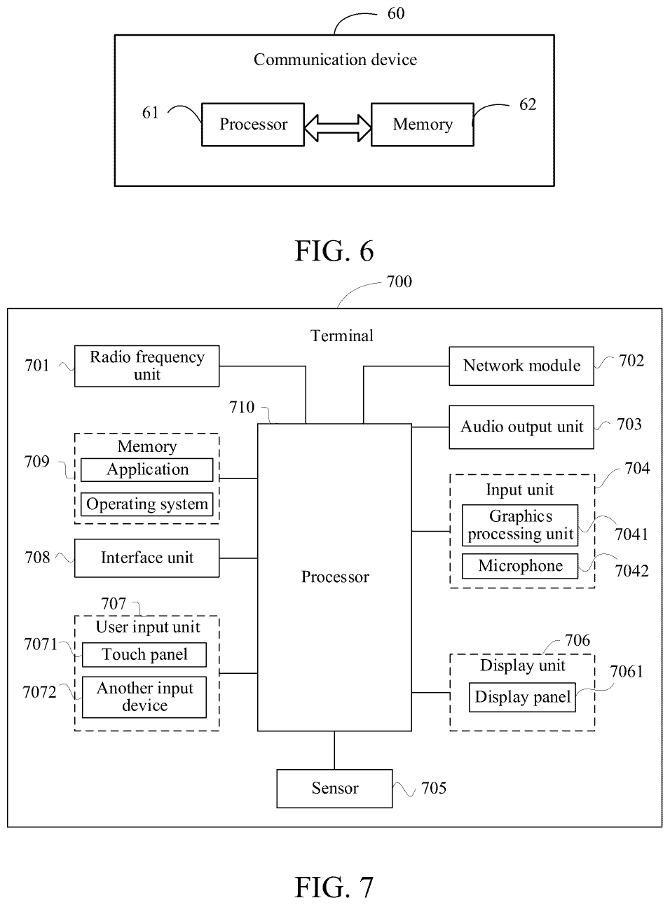

As shown in FIG. 6, the embodiments of the present disclosure further provide a communication device 60. The communication apparatus includes a processor 61 and a memory 62, and the memory 62 stores a program or an instruction that is runnable on the processor 61. For example, when the communication device 60 is a terminal, the program or the instruction implements steps of the embodiment of the method for measuring a cell when executed by the processor 61, and can achieve the same technical effect. When the communication device 60 is a network side device, the program or the instruction implements steps of the embodiment of the method for configuration when executed by the processor 61, and can achieve the same technical effect, which is not repeated herein for avoiding repetition.

The embodiments of the present disclosure further provide a terminal. The terminal includes a processor and a communication interface. The communication interface is coupled to the processor, and the processor is configured to run a program or an instruction, to implement steps in the embodiment of the method shown in FIG. 2. The embodiment of the terminal corresponds to the embodiment of the terminal side method, and the implementation processes and implementation modes of the embodiment of the method may be applied to the embodiment of the terminal, and can achieve the same technical effect.

Specifically, FIG. 7 is a schematic diagram of a hardware structure of the terminal for implementing the embodiment of the present disclosure.

The terminal 700 includes, but is not limited to, at least some components such as a radio frequency unit 701, a network module 702, an audio output unit 703, an input unit 704, a sensor 705, a display unit 706, a user input unit 707, an interface unit 708, a memory 709, and a processor 710.

It can be understood by those of ordinary skill in the art that the terminal 700 may further include a power supply (such as a battery) for energizing the components, and the power supply may be logically connected to the processor 710 through a power management system, such that the functions of charging, discharging, and power consumption management may be implemented through the power management system. The terminal structure shown in FIG. 7 does not constitute limitation to the terminal, and the terminal may include more or less components than those shown, or combine some components, or arrange components in different ways, which is not repeated herein.

It should be understood that in the embodiment of the present disclosure, the input unit 704 may include a graphics processing unit (Graphics Processing Unit, GPU) 7041 and a microphone 7042, and the graphics processing unit 7041 processes image data of static pictures or videos acquired by an image capture apparatus (such as a camera) in a video capture mode or an image capture mode. The display unit 706 may include a display panel 7061, and the display panel 7061 may be configured in the form of a liquid crystal display or an organic light-emitting diode. The user input unit 707 includes at least one of a touch panel 7071 and another input device 7072. The touch panel 7071 is also referred to as a touchscreen. The touch panel 7071 may include a touch detection apparatus and a touch controller. Another input device 7072 may include, but is not limited to, a physical keyboard, a function key (such as a volume control button and a switch button), a trackball, a mouse, and a joystick, which is not repeated herein.

In the embodiment of the present disclosure, after receiving downlink data from the network side device, the radio frequency unit 701 may transmit the data to the processor 710 for processing. In addition, the radio frequency unit 701 may send uplink data to the network side device. Generally, the radio frequency unit 701 includes, but is not limited to, an antenna, an amplifier, a transceiver, a coupler, a low noise amplifier, and a duplexer.

The memory 709 may be configured to store the software program or instruction and various data. The memory 709 may mainly include a first storage area for storing the program or instruction and a second storage area for storing the data. The first storage area may store an operating system, an application program, or instruction (for example, a sound playback function, and an image display function) required for at least one function, etc. In addition, the memory 709 may include a volatile memory or nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in embodiments of the present disclosure includes, but is not limited to, these and any other suitable types of memory.

The processor 710 may include one or more processing units. Optionally, the processor 710 integrates an application processor and a modem processor. The application processor mainly processes an operating system, a user interface, an application program, etc., and the modem processor mainly processes a wireless communication signal, such as a baseband processor. It can be understood that the modem processor may alternatively not be integrated into the processor 710.

The processor 710 is configured to measure a neighboring cell by using an LP-WUR.

It can be understood that reference can be made to the relevant description of the embodiment of the method for measuring a cell for the implementation processes of the implementations mentioned in this embodiment, and the same or corresponding technical effects are achieved, which is not repeated herein for avoiding repetition.

The embodiments of the present disclosure further provides a network side device. The network side device includes a processor and a communication interface. The communication interface is coupled to the processor, and the processor is configured to run a program or an instruction, to implement steps of the embodiment of the method for configuration shown in FIG. 3. The embodiment of the network side device corresponds to the embodiment of the network side device method, and the implementation processes and implementation modes of the embodiment of the method may be applied to the embodiment of the network side device, and can achieve the same technical effect.

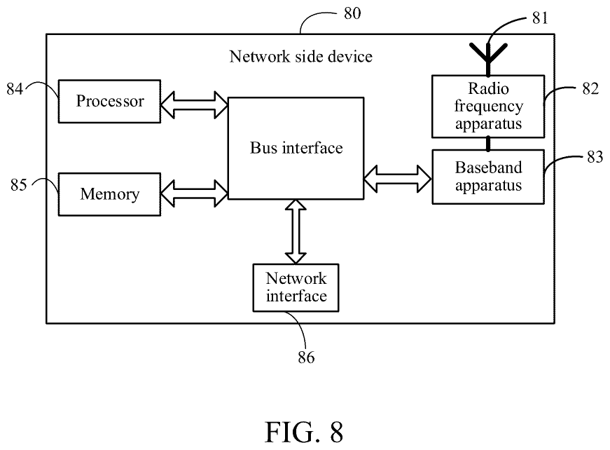

Specifically, the embodiments of the present disclosure further provide a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81 and sends the received information to the baseband apparatus 83 for processing. In a downlink direction, the baseband apparatus 83 processes the information to be sent and sends the information to the radio frequency apparatus 82, and the radio frequency apparatus 82 processes the received information and sends the information through the antenna 81.

The method performed by the network side device in the embodiment may be implemented in the baseband apparatus 83, and the baseband apparatus 83 includes a baseband processor.

For example, the baseband apparatus 83 may include at least one baseband board, and a plurality of chips are arranged on the baseband board, as shown in FIG. 8. One chip is the baseband processor for example, and is connected to the memory 85 through a bus interface, so as to invoke a program from the memory 85 and perform the network device operation shown in the embodiment of the method.

The network side device may further include a network interface 86. The network interface is, for example, a common public radio interface (Common Public Radio Interface, CPRI).

Specifically, the network side device 800 of the embodiment of the present disclosure further includes an instruction or a program that is stored on the memory 85 and is runnable on the processor 84. The processor 84 invokes the instruction or the program from the memory 85 to perform the methods performed by the modules shown in FIG. 5, and achieves the same technical effect, which is not repeated herein for avoiding repetition.

The embodiments of the present disclosure further provide a readable storage medium. The readable storage medium stores a program or an instruction. When executed by a processor, the program or the instruction implements the processes of the embodiment of the method for measuring a cell described above or the processes of the embodiment of the method for configuration described above, and can achieve the same technical effect, which is not repeated herein for avoiding repetition

The processor is a processor in a terminal described in the embodiment. The readable storage medium includes a computer-readable storage medium, such as a computer read-only memory (ROM), a random access memory (RAM), a magnetic disk, and an optical disk. In some examples, the readable storage medium may be a non-transitory readable storage medium.

The embodiments of the present disclosure further provide a chip. The chip includes: a processor and a communication interface. The communication interface is coupled to the processor, and the processor is configured to run a program or an instruction to implement the processes of the embodiment of the method for measuring a cell described above or the processes of the embodiment of the method for configuration described above, and can achieve the same technical effect, which is not repeated herein for avoiding repetition

It should be understood that the chip in the embodiment of the present disclosure may be referred to as a system on chip, a system chip, a chip system, an on-chip system chip, etc.

The embodiments of the present disclosure further provide a computer program/program product. The computer program/program product is stored in a storage medium, and the computer program/program product is executed by at least one processor to implement the processes of the embodiment of the method for measuring a cell described above or the processes of the embodiment of the method for configuration described above, and can achieve the same technical effect, which is not repeated herein for avoiding repetition.

The embodiments of the present disclosure further provide a communication system. The communication system includes a terminal and a network side device. The terminal may be configured to perform steps of the method for measuring a cell described above, and the network side device may be configured to perform steps of the method for configuration described above.

It should be noted that in this context, the terms “comprise”, “include”, or their any other variation is intended to cover non-exclusive inclusion, such that a process, a method, an article or an apparatus including a series of elements include those elements, and further includes other elements not listed clearly, or further include elements inherent to such a process, method, article or apparatus. In a case of no more limitation, an element limited with the phrase “comprise a/an.. .”or “include a/an.. .” does not exclude another same element from the process, method, article or apparatus including the element. In addition, it should be noted that the range of the method and apparatus in the implementation of the present disclosure is not limited to implementation of functions in order shown or discussed, and can further include implementation of functions involved in a substantially simultaneous manner or in reverse order. For example, the method described can be performed in order different from that described, and various steps can be added, omitted, or combined. In addition, features described with reference to some examples can be combined in other examples.

It can be clearly understood by those of ordinary skill in the art from the description of the implementation that the embodiment of the method can be implemented through computer software products and necessary general hardware platforms, and may alternatively be implemented through the hardware certainly. The computer software products are stored in the storage medium (such as an ROM/RAM, a diskette, and an optical disk), and include several instructions to make the terminal or the network side device perform the method of the embodiments of the present disclosure.

The embodiments of the present disclosure have been described above with reference to the accompanying drawings, but the present disclosure is not limited to the above specific implementation, which are merely illustrative rather than restrictive. Under the inspiration of the present disclosure, those of ordinary skill in the art can make implementations of many forms without departing from the purposes of the present disclosure and the protection scope of the claims, and these implementations should fall within protection of the present disclosure.

What is claimed is:

1. A method for measuring a cell, comprising:
measuring, by a terminal, a neighboring cell by using a low power wake up radio (LP-WUR).

2. The method according to claim 1, wherein the measuring, by a terminal, a neighboring cell by using a low power wake up radio (LP-WUR) comprises either of the following:
in a case that a first information is received by the terminal, measuring the neighboring cell by using the LP-WUR according to the first information; and
in a case that the first information is not received by the terminal, measuring the neighboring cell by using the LP-WUR according to a frequency point information or a cell information in a first system information block (SIB), and synchronization signal block (SSB) measurement timing configuration (SMTC) information; wherein
the first information comprises at least one of the following:
a first indication information corresponding to a first frequency point, the first indication information is used for indicating whether to measure the first frequency point when the terminal measures the neighboring cell by using the LP-WUR;
a second indication information corresponding to a first cell, the second indication information is used for indicating whether to measure the first cell when the terminal measures the neighboring cell by using the LP-WUR;
a third indication information corresponding to a second frequency point and a second cell, the third indication information is used for indicating whether to measure the second frequency point and the second cell when the terminal measures the neighboring cell by using the LP-WUR;
a frequency point information or a cell information, the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR; and
a SMTC information.

3. The method according to claim 2, wherein the measuring the neighboring cell by using the LP-WUR according to the first information comprises:
measuring, by the terminal, the neighboring cell according to the first information and the information in the first SIB by using the LP-WUR in an SMTC window.

4. The method according to claim 1, further comprising:
obtaining, by the terminal, a first offset value, wherein the first offset value is used for compensating for a cell measurement result of measurement by using the LP-WUR.

5. The method according to claim 1, wherein the measuring, by a terminal, a neighboring cell by using a low power wake up radio (LP-WUR) comprises at least one of the following:
in a case that a first condition is satisfied, the terminal measures wireless link quality of the neighboring cell by using the LP-WUR according to information in a first SIB, wherein the first condition comprises at least one of the following: when a master radio is in an ultra-deep sleep state, the terminal stores effective system information or is capable of measuring the neighboring cell; and when in an ultra-deep sleep state, the terminal stores effective system information or is capable of measuring the neighboring cell, and
in a case that a second condition is satisfied, the terminal measures the neighboring cell by using the LP-WUR; wherein the second condition comprises at least one of the following:
a measurement result of a serving cell obtained by using the master radio or the low power wake up radio is lower than or equal to a first threshold; and a measurement result of the neighboring cell obtained by using the master radio is higher than or equal to a second threshold.

6. The method according to claim 1, further comprising:
obtaining, by the terminal, a second information, wherein
the measuring, by a terminal, a neighboring cell by using a low power wake up radio (LP-WUR) comprises:
measuring, by the terminal, the neighboring cell by using the LP-WUR according to the second information, wherein
the second information comprises at least one of the following:
a fourth indication information, the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point, the third information comprises at least one of the following: a fifth indication information and an information of a fourth frequency point; the fifth indication information is used for indicating whether cells associated with the third frequency point are synchronized, and the information of the fourth frequency point is used for indicating that the cell associated with the third frequency point is synchronized with the cell associated with the fourth frequency point;
an information of a fourth cell associated with a third cell, wherein the information of the fourth cell is used for indicating that the third cell is synchronized with the fourth cell;
a configuration information of a low power synchronization signal (LP-SS) or a low power wake up signal (LP-WUS); and
an information of a first window, the first window is configured to be used by the terminal to measure, by using the LP-WUR, the neighboring cell in the first window.

7. The method according to claim 6, wherein the information of the first window comprises at least one of the following:
a cycle of the first window;
an initial position of the cycle of the first window;
an initial offset of the cycle of the first window; and
duration of the first window.

8. The method according to claim 6, wherein when the second information comprises the information of the first window, the terminal measuring the neighboring cell by using the LP-WUR according to the second information comprises at least one of the following:
in a case that the first window is associated with a fifth frequency point, the terminal measures a cell associated with the fifth frequency point in the first window by using the LP-WUR according to the information of the first window;
in a case that the first window is associated with a fifth cell, the terminal measures the fifth cell in the first window by using the LP-WUR according to the information of the first window; and
in a case that the first window is associated with the terminal, the terminal measures a neighboring cell associated with the terminal in the first window by using the LP-WUR according to the information of the first window.

9. The method according to claim 6, wherein the configuration information of the LP-SS or the low power wake up signal (LP-WUS) comprises a configuration information of an LP-SS or an LP-WUS of a cell associated with the terminal; wherein
the configuration information of the LP-SS or the LP-WUS of the cell associated with the terminal comprises at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
a monitoring duration of the LP-SS or the LP-WUS of the cell associated with the terminal; and
a monitoring time window of the LP-SS or the LP-WUS of the cell associated with the terminal.

10. The method according to claim 6, further comprising:
the terminal obtains a fourth information, wherein the fourth information comprises that time domain positions of the LP-SSes or the LP-WUSes between cells associated with the terminal are related.

11. The method according to claim 10, wherein the fourth information comprises either of the following:
the time domain positions of the LP-SSes or the LP-WUSes between the cells associated with the terminal are the same; and
a first time domain position and a second time domain position are separated by N times a second offset value or a third offset value, wherein N is an integer greater than or equal to 1, the first time domain position is a time domain position of an LP-SS or an LP-WUS of a seventh cell, the second time domain position is a time domain position of an LP-SS or an LP-WUS of a sixth cell, and the second time domain position is used for determining a time domain position of an LP-SS or an LP-WUS of another cell in the cells associated with the terminal except the sixth cell.

12. The method according to claim 11, wherein the configuration information of the LP-SS or the low power wake up signal (LP-WUS) comprises the time domain position of the LP-SS or the LP-WUS of the sixth cell and a configuration information of the seventh cell, and the configuration information of the seventh cell comprises at least one of the following:
the second offset value;
the third offset value or the N; and
a seventh indication information, wherein the seventh indication information is used for indicating that the time domain position of the LP-SS or the LP-WUS of the seventh cell is positively offset or negatively offset relative to the time domain position of the LP-SS or the LP-WUS of the sixth cell.

13. The method according to claim 6, wherein the measuring, by the terminal, the neighboring cell by using the LP-WUR according to the second information comprises:
in a case that a third condition is satisfied, the terminal measures the neighboring cell by using the LP-WUR according to the second information, wherein the third condition comprises at least one of the following:
when a master radio is in an ultra-deep sleep state, the terminal is capable of measuring the neighboring cell; and
when in an ultra-deep sleep state, the terminal is capable of measuring the neighboring cell.

14. A method for configuration, comprising:
sending, by a network side device, a first information or a second information to a terminal, wherein the first information is used for measuring a neighboring cell by using an LP-WUR, and the second information is used for measuring the neighboring cell by using the LP-WUR;
wherein, the first information comprises at least one of the following:
a first indication information corresponding to a first frequency point, the first indication information is used for indicating whether to measure the first frequency point when the terminal measures the neighboring cell by using the LP-WUR;
a second indication information corresponding to a first cell, the second indication information is used for indicating whether to measure the first cell when the terminal measures the neighboring cell by using the LP-WUR;
a third indication information corresponding to a second frequency point and a second cell, the third indication information is used for indicating whether to measure the second frequency point and the second cell when the terminal measures the neighboring cell by using the LP-WUR;
a frequency point information or a cell information, wherein the frequency point information is used for indicating that a frequency point corresponding to the frequency point information need to be measured when the terminal measures the neighboring cell by using the LP-WUR, and the cell information is used for indicating that a cell corresponding to the cell information need to be measured when the terminal measures the neighboring cell by using the LP-WUR;
a SMTC information; and
the second information comprises at least one of the following:
a fourth indication information, wherein the fourth indication information is used for indicating either of the following: whether all neighboring cells measured by the terminal using the LP-WUR are synchronized with a serving cell, and whether a common frequency neighboring cell measured by the terminal using the LP-WUR is synchronized with the serving cell;
a third information associated with a third frequency point, wherein the third information comprises at least one of the following: a fifth indication information and an information of a fourth frequency point, the fifth indication information is used for indicating whether cells associated with the third frequency point are synchronized, and the information of the fourth frequency point is used for indicating that the cell associated with the third frequency point is synchronized with the cell associated with the fourth frequency point;
an information of a fourth cell associated with a third cell, wherein the information of the fourth cell is used for indicating that the third cell is synchronized with the fourth cell;
a configuration information of an LP-SS or an LP-WUS; and
an information of a first window, wherein the first window is configured to be used by the terminal to measure, by using the LP-WUR, the neighboring cell in the first window.

15. The method according to claim 14, wherein the information of the first window comprises at least one of the following:
a cycle of the first window;
an initial position of the cycle of the first window;
an initial offset of the cycle of the first window; and
duration of the first window.

16. The method according to claim 14, wherein
the first window is associated with a fifth frequency point, and the information of the first window is used for measuring a cell associated with the fifth frequency point in the first window by using the LP-WUR;
or
the first window is associated with a fifth cell, and the information of the first window is used for measuring the fifth cell in the first window by using the LP-WUR;
or
the first window is associated with the terminal, and the information of the first window is used for measuring a neighboring cell associated with the terminal in the first window by using the LP-WUR.

17. The method according to claim 14, wherein the configuration information of the LP-SS or the LP-WUS comprises a configuration information of an LP-SS or an LP-WUS of a cell associated with the terminal; wherein
the configuration information of the LP-SS or the LP-WUS of the cell associated with the terminal comprises at least one of the following:
an identifier of the cell associated with the terminal;
a cycle of the LP-SS or the LP-WUS of the cell associated with the terminal;
an initial position of the LP-SS or the LP-WUS of the cell associated with the terminal;
an initial offset of the LP-SS or the LP-WUS of the cell associated with the terminal;
a signal sequence of the LP-SS or the LP-WUS of the cell associated with the terminal;
a monitoring timing of the LP-SS or the LP-WUS of the cell associated with the terminal;
a monitoring duration of the LP-SS or the LP-WUS of the cell associated with the terminal; and
a monitoring time window of the LP-SS or the LP-WUS of the cell associated with the terminal.

18. The method according to claim 14, further comprising:
sending, by the network side device, an eighth indication information to the terminal, wherein the eighth indication information is used for indicating that time domain positions of LP-SSes or LP-WUSes between cells associated with the terminal are related.

19. A terminal, comprising a processor and a memory, wherein the memory stores a program or an instruction that is runnable on the processor, and the program or the instruction implements a method for measuring a cell when executed by the processor, the method comprising:
measuring, by the terminal, a neighboring cell by using a low power wake up radio (LP-WUR).

20. A network side device, comprising a processor and a memory, wherein the memory stores a program or an instruction that is runnable on the processor, and the program or the instruction implements steps of the method for configuration according to claim 14 when executed by the processor.
